(19) United States
(12) Patent Application Publication
(10) Pub. No.: US 2017/0017520 A1
(43) Pub. Date: Jan. 19, 2017

(54) SYSTEM AND CONTROL METHOD

(71) Applicant: CANON KABUSHIKI KAISHA, Tokyo (JP)

(72) Inventor: Toshiyuki Nakazawa, Tokyo (JP)

(21) Appl. No.: 15/208,242

(22) Filed: Jul. 12, 2016

(30) Foreign Application Priority Data
Jul. 13, 2015 (JP) 2015-140048

(51) Int. Cl. G06F 9/48; G06F 17/30

(52) U.S. Cl. CPC G06F 9/4881; G06F 17/3056

(57) ABSTRACT

A system is provided in which a scheduler of each environment acquires task information associated with its own identification information from a database to control execution of a task. With respect to task information that is not executed by a scheduler in any environment in operation, a scheduler in a production environment controls execution of the task.

### BACKGROUND OF THE INVENTION

Field of the Invention

The present invention relates to a technique for controlling execution of a task when a plurality of modules such as schedulers exist.

Description of the Related Art

Conventionally, when data processing is executed by a computer, a technique is known in which a module such as a scheduler manages a plurality of tasks corresponding to each data processing to control a processing order by using a queue (e.g., Japanese Patent Application Laid-Open No. 2009-176146). Herein, “task” is a unit of processing managed by a queue, which is also referred to as “job”. There is also a system in which task execution control modules such as a plurality of schedulers registers tasks in a common queue to process the tasks in sequence.

Further, in recent years, a system called “cloud computing” which provides applications and services through a technique using virtualization technology can be established on a network such as the internet. In the above-described system, a technique called blue-green deployment is provided as a method for upgrading a version without stopping the applications and the services.

In the blue-green deployment, two execution environments called a blue environment and a green environment are provided, and systems are established by operating the applications and the services in the respective environments. Herein, when the above technique is employed to upgrade the version, upgraded applications and services are operated in the green environment.

A system established in the blue environment is currently released on the internet, and a request from the outside of the system is transferred to the system established in the blue environment via a router or a domain name system (DNS) to be processed therewith. In the blue-green deployment, a processing/execution environment of the request is switched by changing setting of the router and transferring the request from the outside of the system to a system established in the green environment, so as to realize version upgrade of the system. In addition, in order to enable a user to use a processing result or data accumulated so far even after the version upgrade, the systems established in respective environments are configured to share the database.

Assume that above-described schedulers operate to realize data processing relating to a plurality of tasks in the systems established in the blue environment and the green environment by using a database shared by these environments. A task that defines processing corresponding to a request from the outside of the system and a task that defines processing necessary to be executed periodically are managed thereby.

### SUMMARY OF THE INVENTION

However, for example, the scheduler operating in the system in the blue environment may attempt to manage a task by using the database shared with the green environment without taking the switch-over of the processing environment into consideration. In such a case, there is a problem in that the scheduler operating in the system in the green environment takes out a task that should be originally handled by the scheduler operating in the system in the blue environment and executes that task in the system in the green environment.

Accordingly, in accordance with an aspect of the present invention, a method is provided for ensuring an execution control module for executing each task in a case where a plurality of execution control modules respectively operating in a plurality of environments performs execution control of tasks managed by a database shared therewith.

According to another aspect of the present invention, a system establishing one or more execution environments in which a task corresponding to task information managed in a database is executed, includes execution control units respectively operating in a plurality of execution environments which are configured to control execution of a task corresponding to task information conforming to a first condition from among the task information managed in the database which is associated with identification information of the execution control units. In a plurality of the execution control units respectively operating in a plurality of the execution environments, a first mode is set to any one execution control unit as an operation mode whereas a second mode different from the first mode is set to the other execution control units as operation modes, and the execution control unit to which the first mode is set also acquires task information conforming to a second condition different from the first condition from the database and controls execution of a task corresponding to the acquired task information.

Further features of the present invention will become apparent from the following description of exemplary embodiments with reference to the attached drawings.

### BRIEF DESCRIPTION OF THE DRAWINGS

FIG. 1 is a block diagram illustrating a configuration example of an entire system according to the present invention.

FIG. 2 is a block diagram illustrating an example of a hardware configuration of an information processing apparatus.

FIG. 3 is a block diagram illustrating an internal configuration of each environment in more detail.

FIG. 4 is a block diagram illustrating a configuration example of a virtual machine.

FIGS. 5A to 5D are diagrams illustrating examples of contents of task information.

FIGS. 6A and 6B are flowcharts illustrating processing relating to task execution control executed by a scheduler.

FIG. 7 is a flowchart illustrating task execution processing.

FIG. 8 is a flowchart illustrating environment switching processing executed by a switching control unit.

FIGS. 9A and 9B are flowcharts illustrating processing for determining an operation mode of a scheduler.

FIG. 10 is a flowchart illustrating registration processing of task information executed by a scheduler.

### DESCRIPTION OF THE EMBODIMENTS

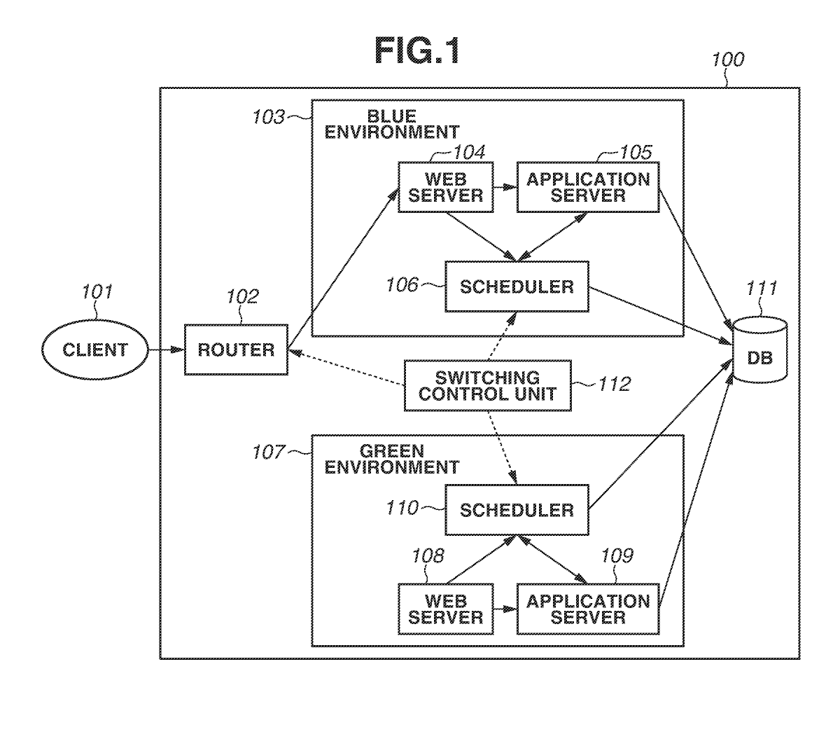

Hereinafter, an exemplary embodiment embodying the present invention will be described with reference to the appended drawings. FIG. 1 is a block diagram illustrating a configuration example of an entire system according to the present invention.

A client 101 is a terminal through which a user uses a service provided by a production environment (blue environment 103) of the system. The client 101 accesses a system 100 to transmit a request by using a web browser. A plurality of clients that uses the service provided by the system 100 may exist outside the system 100 in addition to the client 101. In such a case, these clients respectively transmit requests to the system 100.

A router 102 receives a request with respect to the system 100 from the client 101 and transfers the request to the appropriate execution environment. At present, because two execution environments operate in the system 100 while the blue environment 103 is released as a production environment, the router 102 transfers a request from the client 101 to the blue environment 103. Herein, the execution environment such as the blue environment 103 which releases the service to the client 101 outside the system 100 is called as “production environment”. On the other hand, a green environment 107 which does not release the service to the client 101 outside the system 100 is called as “test environment” or “preliminary environment”. Although the green environment 107 does not release the service to the client 101 outside the system 100, internal configurations thereof are usually operating, so that a system administrator can use the system by accessing thereto. Further, the green environment 107 may be provided more than one. In addition, each of the environments such as the blue environment 103 and the green environment 107 includes a unique environment identifier as attribute information. The configuration such as a scheduler included in each of the environments can refer to the environment identifier.

The blue environment 103 is configured of a web server 104, an application server 105, and a scheduler 106. A plurality of the web servers 104 and the application servers 105 may be established, and these servers 104 and 105 are realized with virtual machines operating on one or more server computer.

The web server 104 receives a request from the client 101, calls the application server 105 as necessary, and returns a processing result of the request to the client 101. The application server 105 receives a request from the web server 104 or the scheduler 106, executes processing according to the request, and returns a processing result to a calling source. Further, the application server 105 operates data within a database 111 as necessary before or after receiving the request.

The scheduler 106 receives task information as a request from the web server 104 or the application server 105 via a predetermined web application program interface (API), and stores the task information in the database 111. In the database 111, the task information is managed by a task information table. The scheduler 106 periodically refers to the task information table and executes a task corresponding to the task information according to schedule information of the task information being managed. For example, the scheduler 106 executes a task by calling a function of the application server 105.

The database 111 is accessible from applications, services, or schedulers within the systems in both the blue environment 103 and the green environment 107.

Basically, the green environment 107 has a configuration similar to that of the blue environment 103. However, a version of the application or the service operating in the green environment 107 (e.g., a program operating on a web server 108 or an application server 109) is different. A scheduler 110 having a function similar to that of the scheduler 106 is operating in the green environment 107.

A switching control unit 112 executes environment switching processing for switching a processing environment of the request from the client 101, from the blue environment 103 to the green environment 107. This environment switching processing is executed according to an instruction input by the administrator of the system 100, or automatically executed according to a schedule previously set thereto. In addition, to test an operation, each constituent element included in the green environment 107 is operated concurrently with constituent elements in the blue environment 103 for a predetermined period. During the operational test, the scheduler 110 operates internal task execution control, and a request manually input by the administrator is executed by the web server 108 or the application server 109. When the operational test is sufficiently completed, the switching control unit 112 executes environment switching processing at a timing described above.

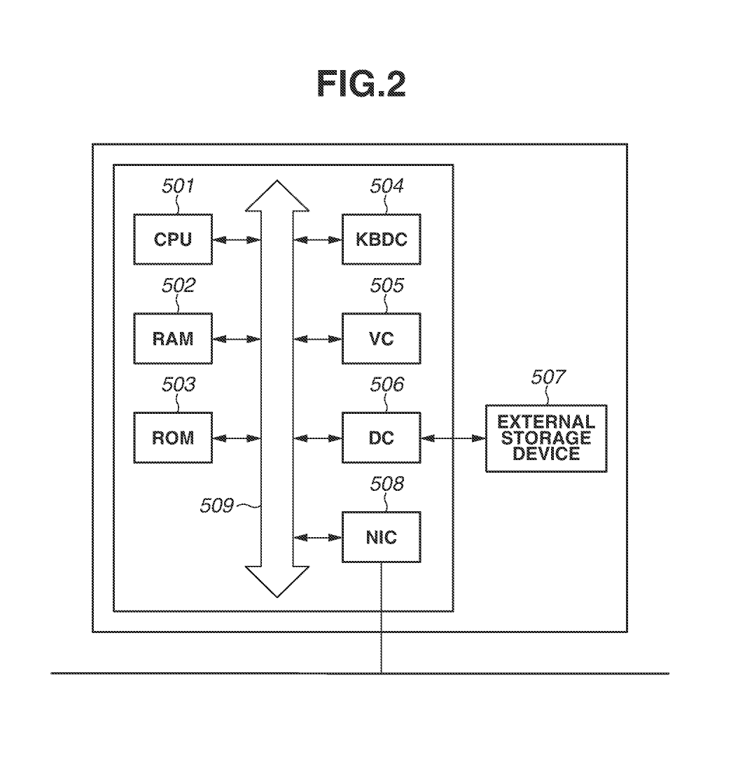

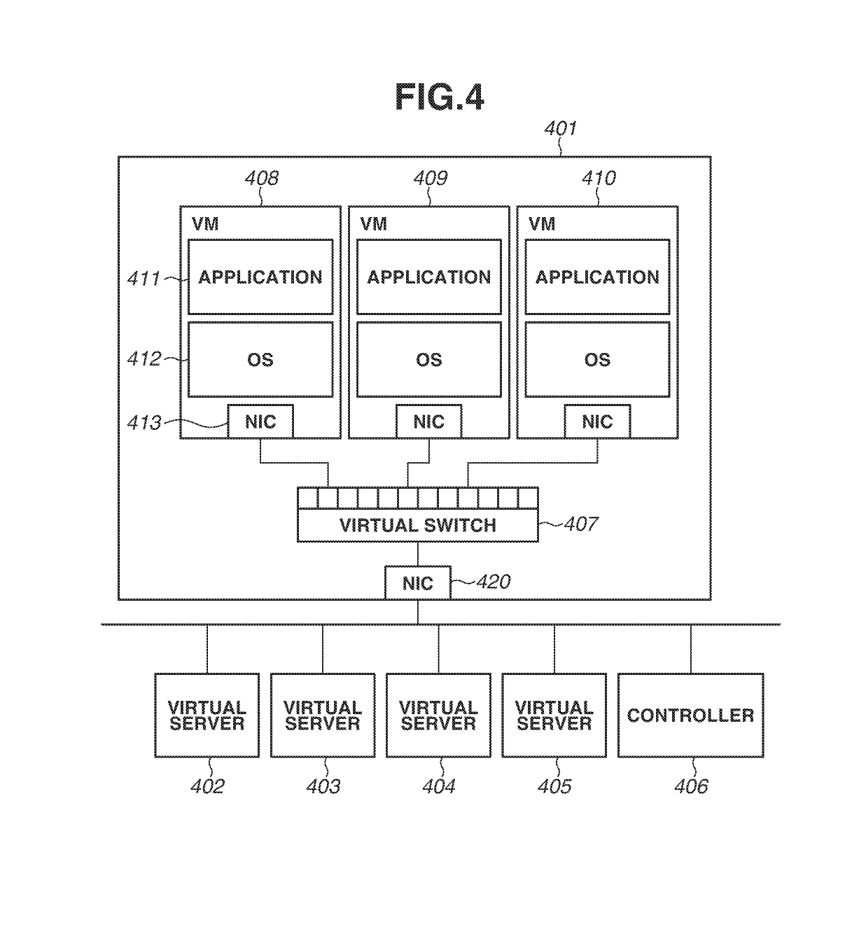

FIG. 2 is a block diagram illustrating a hardware configuration of an information processing apparatus including a server computer in which a virtual machine operates. In FIG. 2, the information processing apparatus includes a central processing unit (CPU) 501, a random access memory (RAM) 502, a read only memory (ROM) 503, and an external storage device 507. The CPU 501 executes the software stored in the ROM 502 or the external storage device 507 or the software downloaded from a network, and comprehensively controls devices connected to a system bus 509. The RAM 502 functions as a main memory or a work area of the CPU 501. The external storage device 507 is configured of a hard disk (HD) or a solid state drive (SSD). The external storage device 507 stores various applications, database data, and user files, such as a boot program, an operating system, an authentication server, and an authentication client. Further, in the information processing apparatus, a keyboard controller (KBDC) 504 transmits information received from a keyboard or a pointing device to the CPU 501. A video controller (VC) 505 executes display control of a display device configured of a liquid crystal display (LCD). A disk controller (DC) 506 controls access to the external storage device 507. The information processing apparatus is connected to the network through a network interface controller (NIC) 420. Virtual software called a hypervisor emulates a virtual machine (VM) described below with reference to FIG. 4.

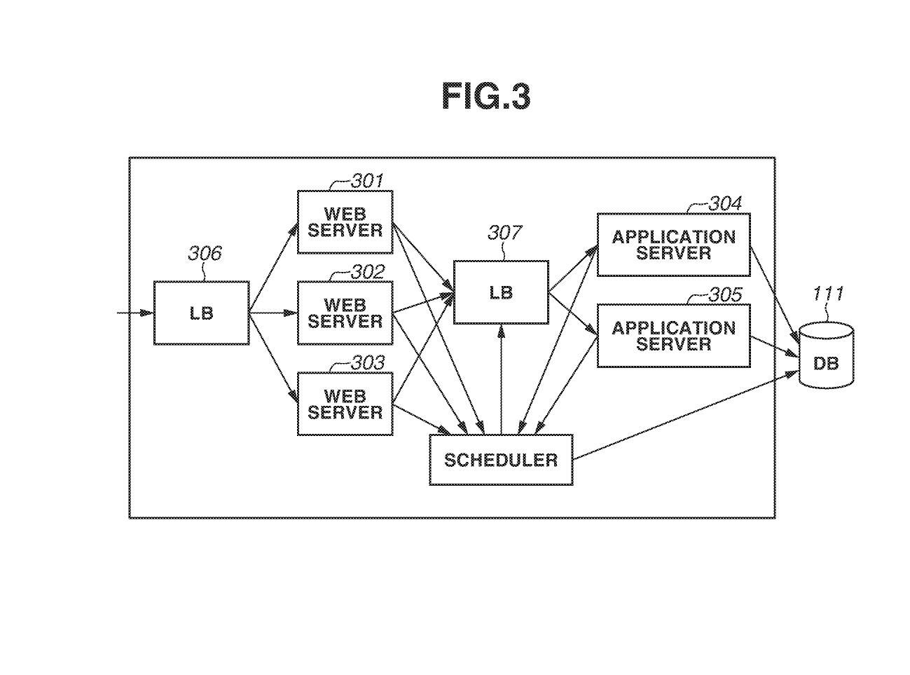

FIG. 3 is a block diagram illustrating internal configurations of the blue environment 103 and the green environment 107 described in FIG. 1 in more detail. In FIG. 3, the same web applications operate on web servers 301, 302, and 303 and the same applications operate on application servers 304 and 305.

A load balancer (LB) 306 executes load distribution by allocating the requests from the client 101 to the web servers 301 to 303. Further, a LB 307 executes load distribution by allocating the requests from the web servers 301 to 303 and the scheduler 106 to any of the application servers 304 and 305. The web server 301 to 303, the application servers 304 and 305, and the scheduler are realized as virtual machines.

The scheduler in FIG. 3 corresponds to either of the schedulers 106 or 110. Further, the web server 104 in FIG. 1 corresponds to the LB 306 and the web servers 301, 302, and 303, whereas the application server 105 corresponds to the LB 307 and the application servers 304, and 305.

FIG. 4 is a block diagram illustrating configurations of virtual servers providing virtual machines and a controller. In FIG. 4, a controller 406 comprehensively controls virtual servers 401 to 405. These virtual servers 401 to 405 and the controller 406 are mutually connected to each other via a network. In FIG. 4, an internal structure of the virtual server is illustrated in the inside of the virtual server 401. This structure is common to all of the virtual servers 401 to 405.

A plurality of virtual machines 408, 409, and 410 operate within the virtual server 401. The virtual machine 408, 409, or 410 emulates a host computer, and an operating system 412 and an application 411 running on the operating system 412 operate therein. A virtual NIC 413 emulates a communication controller and executes data transmission/reception with other virtual NICs connected to the network via a virtual switch 407 and the NIC 420. The virtual switch 407 is software that emulates a switching hub, and controls communication between the virtual NICs within the virtual machines 408 to 410 and the NIC 420 within the virtual server 401. Software that realizes the virtual machines 408 to 410 in the virtual server 401 is called as “hypervisor”. The controller 406 manages settings of the virtual machines 408 to 410 and the virtual switch 407 within the virtual server 401. For example, the controller 406 increases or decreases the number of web servers or application servers according to a load. Further, the controller 406 monitors the application 411 operating in the virtual machine 408, and stops the virtual machine 408 if any failure is detected in the application 411.

### <Description of Task Information According to Present Invention>

The scheduler 106 stores task information in the database 111 and controls execution of a task according to the task information. The web server 104 and the application server 105 can instruct the scheduler 106 to register or change the task via the web API.

Herein, Table 1 illustrates contents (format) of the task information stored and managed in the database 111.

TABLE 1
Table: Content of Task Information

| Column Name | Description |
|---|---|
| Scheduler ID | A string of letters uniquely identifying |
| | a scheduler. |
| Task Name | A string of letters uniquely identifying |
| | a task which is specified upon |
| | registration of the task. |
| Scheduled | Next execution date/time of a task. |
| Execution | |
| Date/Time | |
| Repetition | Repetition setting stored in a JSON |
| Setting | format when a task is a repetitive task. |
| Task Type | Task type (Message Queue or Web API |
| | Call) |
| Detail | Task detail stored in a JSON format. |

“Scheduler Identifier (ID)” is identification information (string of letters) uniquely identifying an instance of each scheduler generated from a universally unique identifier (UUID) when each of the schedulers is activated. The instances of different schedulers have different scheduler IDs. For example, the scheduler 106 sets its own scheduler ID when the task information is added or changed.

“Task Name” is a string of letters uniquely identifying the task information stored in the database 111 specified by a registration source of the task information.

“Scheduled Execution Date/Time” is schedule information at which a task according to the task information is to be executed. The scheduled execution date/time is specified by “Year/Month/Date/Time”. If the task information indicates a repetitive task, “Scheduled Execution Date/Time” is calculated from a repetition setting described below at a time that the task is registered or executed. If the task is not the repetitive task, “Scheduled Execution Date/Time” is specified by a registration source of the task information.

“Repetition Setting” is a repetition setting for repeatedly executing a task. The repetition setting is expressed in a JavaScript Object Notation (JSON) format and specified by a registration source of the task information. In the item “Repetition Setting”, ending date/time that indicates an ending point of the repetition period may be specified together. When “Repetition Setting” is not specified, the task is executed only one time according to the schedule specified in “Scheduled Execution Date/Time”.

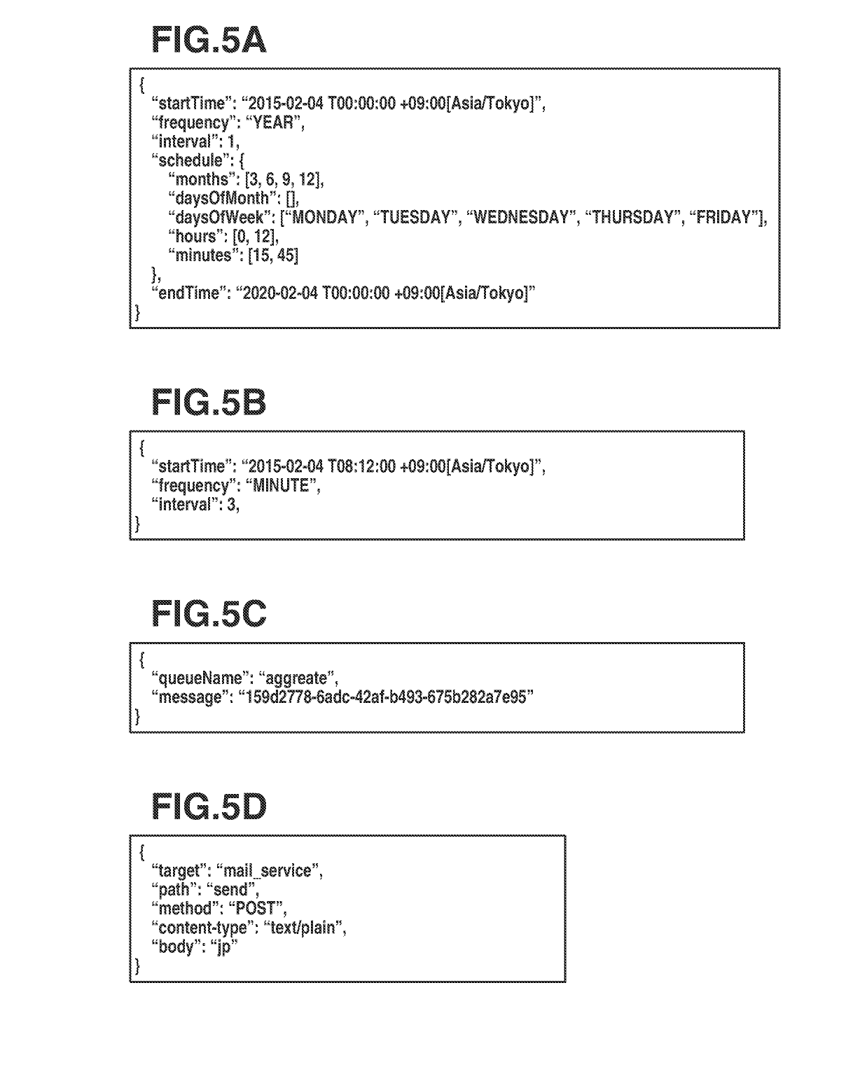

FIG. 5A is a diagram illustrating an example of “Repetition Setting” illustrated in Table 1. In the setting, during a period from Feb. 4, 2015 to Feb. 3, 2020 in Tokyo time, a task will be executed on Monday through Friday at 00:15, 00:45, 12:15, and 12:45 in March, June, September, and December in Tokyo time every year.

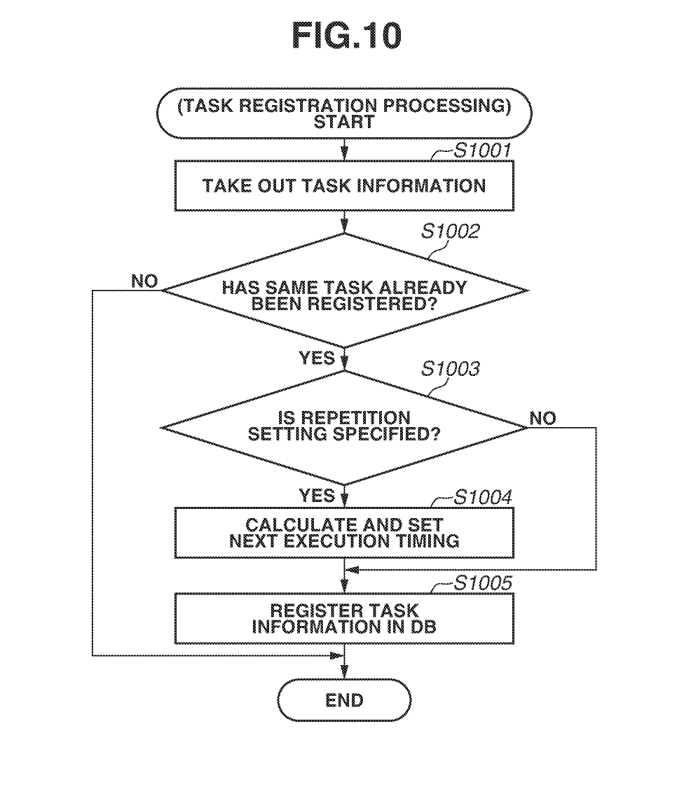

FIG. 5B is a diagram illustrating another example of “Repetition Setting” illustrated in Table 1. In this setting, a task is called at every 3 minutes from Feb. 4, 2015 at 8:12 in Tokyo time. If the above-described repetition setting is specified in the task information, the scheduler 106 calculates the scheduled execution date/time which is the current time or later than and closest to the current time and sets the calculated date/time as “Scheduled Execution Date/Time” of the task when, for example, the task information is to be registered in the database 111 through the processing illustrated in FIG. 10 described below.

“Task Type” is an execution method of the task. For example, the scheduler 106 (110) provides the following two execution methods for the task.

1. Message Queue (MQ): Instructing the application server 105 (109) that receives a message from a message queue to execute the task by transmitting the message corresponding to the task to the message queue.
2. Web API Call (HyperText Transfer Protocol (HTTP)): Instructing the application server 105 (109) to execute the task by calling a web API provided by the application server 105 (109).

“Detail” is a setting detail expressed in a JSON format which is used when the scheduler 106 (110) instructs the application server 105 (109) to execute the task. The scheduler 106 (110) instructs the application server 105 (109) to execute the task by using “Task Type” and “Detail”.

FIG. 5C is a diagram illustrating an example of “Detail” in Table 1 when the task type is the message queue.

In FIG. 5C, a message “159d2778-6adc-42af-b493-675b282a7e95” is to be transmitted to a message queue called “aggregate”. For example, the application server 105 (109) executes processing for periodically taking out a message from the message queue “aggregate”, summarizing information relating to the user having an ID described in the message, i.e., “159d2778-6adc-42af-b493-675b282a7e95”, and storing a result of the summarization in the database 111.

FIG. 5D is a diagram illustrating an example of “Detail” when the task type is the web API call.

“target” indicates a name that is used when an address of a calling destination of the web API (i.e., schema, host, or port) is acquired from the blue environment 103 or the green environment 107. Because the address of the application server 105 (109) varies in the environment 103 (107), the scheduler 106 (110) acquires the address of the application server 105 (109) from the environment 103 (107).

“path” indicates a path for a uniform resource locator (URL) of the web API call. For example, if an address that can be acquired from the environment 103 (107) by specifying “target” is “http://192.168.11.30:8080”, a URL for calling the above web API is “http://192.168.11.30:8080/send”. In the above example, data “jp” is transmitted to this URL in plain text through a POST method. For example, the application server 105 (109) that receives the above request executes processing such as transmitting a mail in a transmission queue to a client whose region is “jp”.

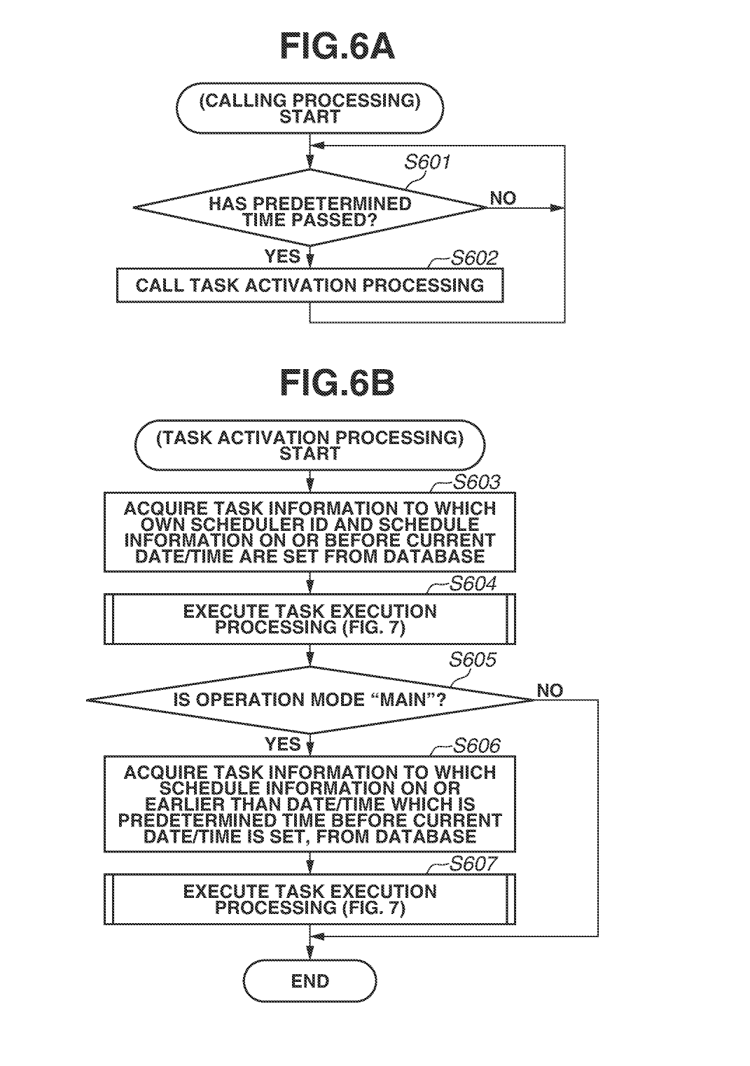

Processing of task execution control executed by the scheduler 106 or 110 will be described with reference to FIGS. 6A and 6B.

FIG. 6A is a flowchart illustrating calling processing of task activation processing executed by the scheduler 106 (110). Through the processing, the task activation processing is periodically called and executed. Further, in this processing, the scheduler 106 (110) executes execution control by acquiring task information conforming to each of conditions from the database 111.

In step S601, the scheduler 106 (110) determines whether predetermined time (e.g., one-minute) has passed. If predetermined time has passed (YES in step S601), the processing proceeds to step S602. In step S602, the scheduler 106 (110) calls task activation processing.

FIG. 6B is a flowchart illustrating the task activation processing executed by the scheduler 106 (110). As described above, the task execution processing is called in step S602.

First, in step S603, the scheduler 106 (110) refers to the task information to which its own scheduler ID is set, from the task information table stored in the database 111. Then, as a first condition, from among the task information, the scheduler 106 (110) identifies the task information in which schedule information (Year/Month/Date/Time) on or before the current date/time is specified in the item “Scheduled Execution Date/Time”, and acquires that task information from the data base 111. A plurality of pieces of task information may be acquired from the task information table.

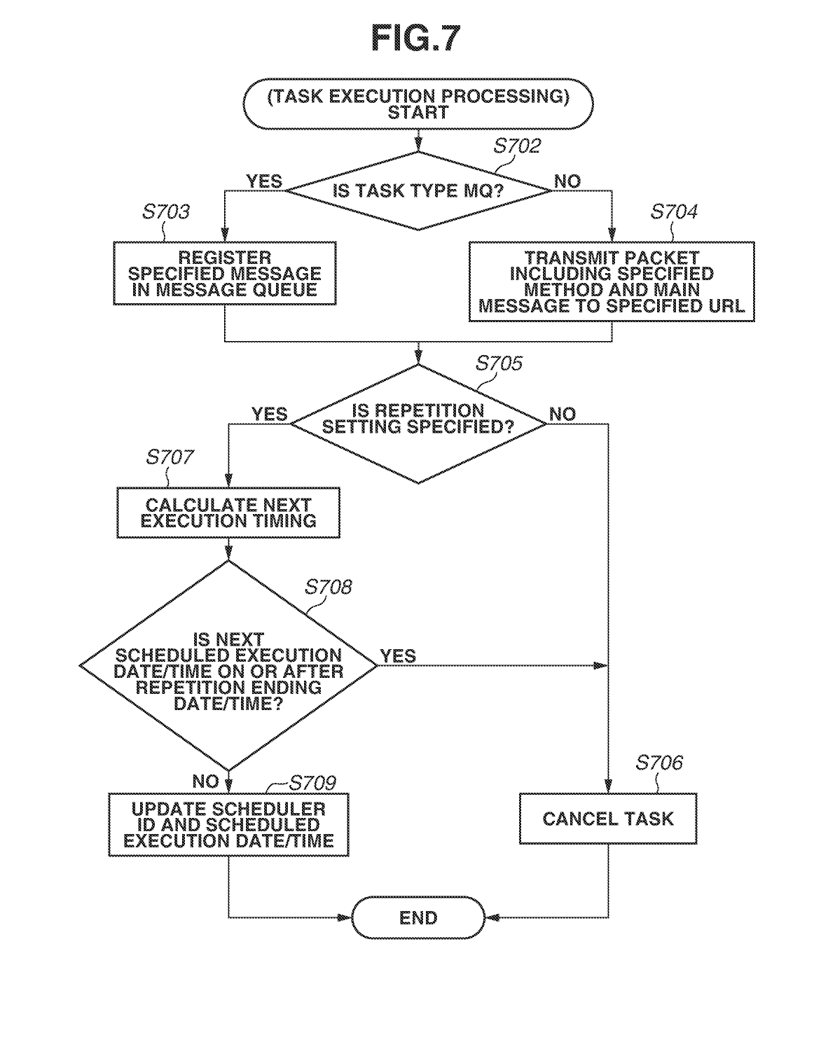

In step S604, the scheduler 106 (110) executes execution processing of a task corresponding to the task information acquired in step S603. When a plurality of pieces of task information is acquired, the execution processing is executed with respect to each of the tasks. Details of the task execution processing will be described below in detail with reference to FIG. 7.

In step S605, the scheduler 106 (110) checks the current mode of its own. An operation mode of the scheduler 106 (110) takes a value that represents either a “main” or “sub” mode. An operation mode of the scheduler 106 (110) in a production environment takes a value representing the “main” mode. An operation mode of the scheduler 106 (110) in a preliminary environment takes a value representing the “sub” mode. In step S605, if the current operation mode is not the “main” mode (NO in step S605), the processing is ended, and if the current operation mode is the “main” mode (YES in step S605), the processing proceeds to step S606.

In step S606, as a second condition, the scheduler 106 (110) identifies the task information in which schedule information on or before date/time which is predetermined time (e.g., 3 minutes) earlier than the current date/time is specified in the item “Scheduled Execution Date/Time”, and acquires that task information from the database 111. In step S607, execution processing of a task corresponding to the task information acquired in step S606 is executed by the scheduler 106 (110). Then, the processing is ended.

In addition, if the above predetermined time in step S601 is X minutes whereas the predetermined time in step S606 is Y minutes, values of “X” and “Y” can be optionally specified to satisfy the following relationship. Herein, the maximum time expected to be necessary to start the task activation processing (FIG. 6B) by executing the calling processing (FIG. 6A) is α.

Y>(2×X)+α Relational Expression:

For example, if the blue environment 103 is the production environment, the scheduler 106 executes the processing in step S606. At this time, in a period between the current date/time and the date/time which is the predetermined time (Y minutes) earlier than the current date/time, it is ensured that the scheduler 110 operating in the sub mode executes the processing in steps S603 and S604 according to the above-described relational expression.

Accordingly, the task information acquired in step S606 is the task information in which identification information different from any of the scheduler IDs of the schedulers 106 and 110 is set to “Scheduler ID”. Further, the scheduler 106 will not acquire the task information by mistake that is to be processed by the scheduler 110.

The task information acquired in the above situation is the task information registered in the database 111 under an environment (not illustrated) used in the past which is different from the blue environment 103 or the green environment 107 illustrated in FIG. 1. In a case where the environment is repeatedly switched by a technique such as the blue-green deployment used in the present invention, task information which is registered by a non-operating scheduler in the environment used in the past may be left in the database 111 without being processed. The system 100 should also execute processing with respect to such task information, in the present exemplary embodiment, so that the scheduler 106 in the current production environment executes the execution control of the task corresponding to such task information in place of the non-operating scheduler.

FIG. 7 is a flowchart illustrating details of the task execution processing performed by the scheduler 106 (110) in steps S604 and S607 in FIG. 6.

In step S702, the scheduler 106 (110) determines a task type of the task information. If the task type is “Message Queue (MQ)” (YES in step S702), the processing proceeds to step S703. In step S703, the scheduler 106 (110) registers a message in a message queue according to the content specified in the item “Detail” of the task information. On the other hand, if the task type is “Web API Call (HTTP)” (NO in step S702), the processing proceeds to step S704. In step S704, the scheduler 106 (110) generates a packet including a specified method and a main message according to the content specified in the item “Detail” of the task information and transmits the packet to the specified URL. Through the processing in step S703 or S704, the task is executed by the application server 105 (109).

In step S705, the scheduler 106 (110) determines whether the repetition setting is specified in the item “Repetition Setting” of the task information. If the repetition setting is not specified (NO in step S705), the processing proceeds to step S706. If the repetition setting is specified (YES in step S705), the processing proceeds to step S707.

In step S706, the scheduler 106 (110) cancels the task information as a processing target stored in the database 111 and ends the processing. Herein, for example, the scheduler 106 (110) may cancel the task information by deleting the task information from the database 111 or setting the schedule information that is assumed as not executable, such as YEAR 9999″, to the item “Scheduled Execution Date/Time” of the task information. With this processing, the cancelled task information will not be acquired in the above-described processing in steps S603 and S606.

In step S707, the scheduler 106 (110) calculates a next execution timing (Year/Month/Date/Time) from the content specified in the item “Repetition Setting” of the task information. Next, in step S708, if the ending date/time is specified in the item “Repetition Setting” of the task information, the scheduler 106 or 110 compares the next execution timing calculated in step S707 with the ending date/time. As a result of the comparison in step S708, if the next execution timing is on or after the ending date/time (YES in step S708), the processing proceeds to step S706. If the next execution timing is before the ending date/time (NO in step S708), the processing proceeds to step S709. In addition, if the ending date/time is not set thereto, the processing in step S708 is omitted, so that the processing proceeds to step S709.

In step S709, the scheduler 106 or 110 uses its own scheduler ID and the next execution timing calculated in step S707 to update the information specified in “Scheduler ID” and “Scheduled Execution Date/Time” of the processing target task information stored in the database 111.

Table 2 is a specific example of the task information table stored and managed in the database 111. The content managed by the task information table may include information other than the content included in this example.

TABLE 2
Task Information Table

| | | Scheduled | | | |
|---|---|---|---|---|---|
| Scheduler | | Execution | Repetition | Task | |
| ID | Task Name | Date/Time | Setting | Type | Detail |
| 550e8400 | sendmail | 2015 May 12 | [--] | mq | [--] |
| | | 12:23:41 | | | |
| 550e8400 | batch1 | 2015 May 12 | [--] | http | [--] |
| | | 13:05:21 | | | |
| 8761d91a | aggregate | 2015 May 12 | [--] | mq | [--] |
| | | 12:20:46 | | | |
| 8761d91a | sendmail | 2015 May 12 | [--] | mq | [--] |
| | | 12:23:16 | | | |
| 550e8400 | cleanup | 2015 May 12 | [--] | http | [--] |
| | | 12:25:28 | | | |
| 619c82b9 | check | 2015 May 12 | null | http | [--] |
| | | 12:22:40 | | | |

Pieces of task information associated with instances of at least three different schedulers (“scheduler IDs” are “550e8400”, “8761d91a”, and “619c82b9”) are registered in the above task information table. Further, “Repetition Setting” is not specified with respect to the task information having a task name “check”.

For example, it is assumed that the scheduler 106 of the blue environment 103 calls the task activation processing illustrated in FIG. 6B at 00-second every minute, whereas the scheduler 110 of the green environment 107 calls the task activation processing illustrated in FIG. 6B at 30-second every minute. Further, the scheduler IDs of the schedulers 106 and 110 are “550e8400” and “619c82b9” respectively. On the other hand, a scheduler ID “8761d91a” represents the identification information of a scheduler in an old environment that is neither the blue environment 103 nor the green environment 107. It is assumed that this scheduler does not operate at present.

Herein, task execution control that is executed according to the task information included in the above task information table will be specifically described.

When the current time has reached 12:23:30 in May 12, 2015, the scheduler 110 acquires task information having a task name “check” in step S603 of FIG. 6B, and executes a task corresponding to that task information in step S604. Because the operation mode of the scheduler 110 is the “sub” mode, the scheduler 110 ends the processing illustrated in FIG. 6B. The task information having the task name “check” is cancelled in step S706 in FIG. 7.

Next, when the current time has reached 12:24:00, the scheduler 106 acquires task information having a task name “sendmail” in step S603 of FIG. 6B, and executes a task corresponding to that task information in step S604. When the scheduler 106 executes a task corresponding to the task information having the task name “sendmail”, in step S709 of FIG. 7, only the item “Scheduled Execution Date/Time” will be updated with respect to the corresponding task information in the above task information table.

Subsequently, in step S606, the scheduler 106 further executes acquisition processing of task information because the operation mode thereof is the “main” mode. Herein, task information having a task name “aggregate”, in which the date/time on or before May 12, 2015, 12:21:00 (i.e., 3 minutes before the current time) is set to “Scheduled Execution Date/Time”, is acquired. In step S607, the scheduler 106 executes a task corresponding to the acquired task information having the task name “aggregate” associated with the scheduler ID “8761d91a”. When the scheduler 106 executes the task corresponding to the task information having the task name “aggregate”, “Scheduled Execution Date/Time” and “Scheduler ID” are updated with respect to the corresponding task information included in the above task information table in step S709 of FIG. 7. Particularly, the item “Scheduler ID” is updated with the identification information “550e8400” indicating the scheduler 106.

By updating the information specified in “Scheduler ID”, the scheduler 106 can execute the task corresponding to the task information having the task name “aggregate” at a timing of step S604 next time and from then onward.

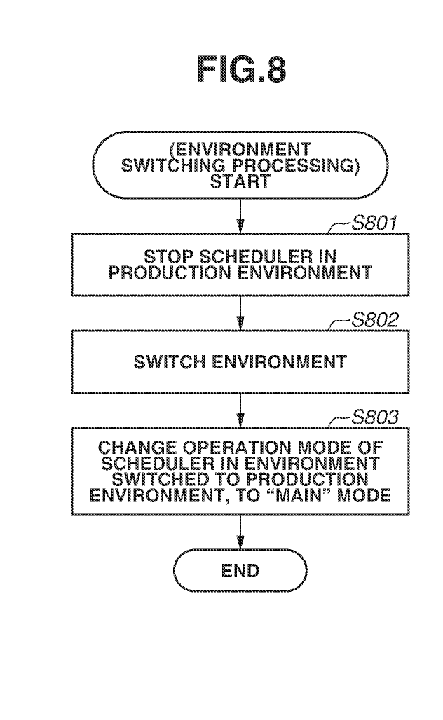

FIG. 8 is a flowchart illustrating environment switching processing executed by the switching control unit 112. Herein, processing for switching a production environment from the blue environment 103 to the green environment 107 will be described in detail. This processing is started according to an instruction input by the administrator of the system 100 or a schedule previously set thereto.

In step S801, the switching control unit 112 stops the scheduler 106 within the blue environment 103 serving as a production environment. The scheduler 106 releases the service to the client 101 outside the system 100. Specifically, the scheduler 106 (110) of the environment 103 (107) provides a web API for stopping the processing, so that the switching control unit 112 calls the web API of the scheduler 106. After the processing for stopping the scheduler 106 is executed, all processings in FIGS. 6A and 6B which are periodically executed are stopped.

In step S802, in order to switch the production environment to the green environment 107, the switching control unit 112 changes a setting of the router 102. In step S803, the switching control unit 112 changes the operation mode of the scheduler 110 in the green environment 107 to “main”. Specifically, the scheduler 106 (110) of the environment 103 (107) provides a web API for changing the operation mode, so that the switching control unit 112 calls the web API of the scheduler 110 to change the operation mode.

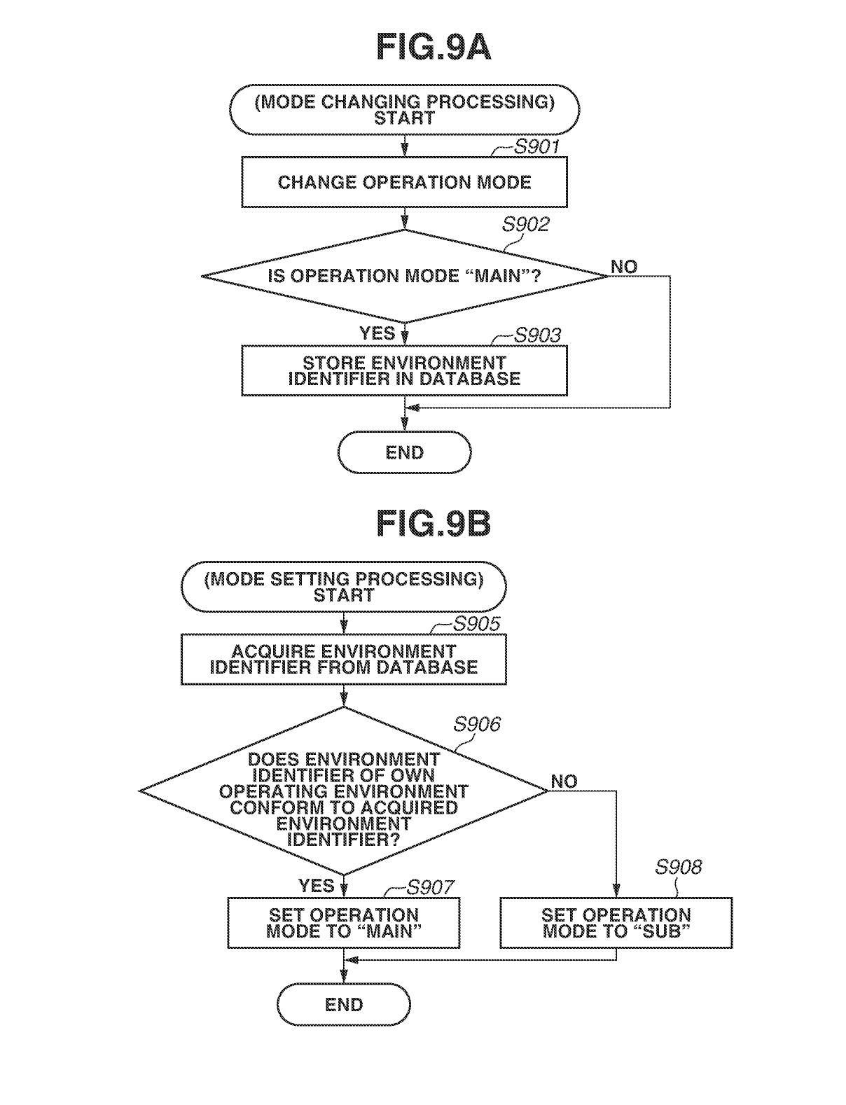

Processing for determining the operation mode of the scheduler 106 (110) will be described with reference to FIGS. 9A and 9B.

FIG. 9A is a flowchart illustrating setting processing of the operation mode of the scheduler 106 (110). This processing is called and executed in the processing in step S803 of FIG. 8. The environment such as the blue environment 103 or the green environment 107 has an environment identifier that uniquely identifies the environment 103 (107), and a program operating in the environment 103 (107) can acquire the environment identifier.

In step S901, the scheduler 106 or 110 changes its own operation mode to a specified mode. Next, in step S902, the scheduler 106 or 110 determines whether the operation mode after making a change is the “main” mode. If the operation mode is the “main” mode (YES in step S902), the processing proceeds to step S903. If the operation mode is not the “main” mode (NO in step S902), the processing is ended.

In step S903, the scheduler 106 or 110 acquires the environment identifier indicating its own operating environment, writes the acquired environment identifier into the database 111, and ends the processing. Through the processing in step S903, the environment identifier of the current production environment is managed in the database 111.

FIG. 9B is a flowchart illustrating setting processing of the operation mode, which is executed by the scheduler 106 (110). This processing is executed when the scheduler 106 (110) is activated.

In step S905, the scheduler 106 or 110 acquires the environment identifier from the database 111. This is a value written into the database 111 in step S903 by the scheduler whose operation mode is the “main” mode.

In step S906, the scheduler 106 or 110 compares the environment identifier of its own operating environment with the environment identifier acquired in step S905. As a result of the comparison, if the environment identifiers conform to each other (YES in step S906), the processing proceeds to step S907. If the environment identifiers do not conform to each other (NO in step S906), the processing proceeds to step S908.

In step S907, the scheduler 106 or 110 sets the own operation mode to “main”. On the other hand, in step S908, the scheduler 106 or 110 sets the own operation mode to “sub”.

According to this processing, for example, if the scheduler 106 operating in the “main” operation mode is stopped for some reason and activated again, the operation mode of the reactivated scheduler 106 is set to the “main” mode. Further, in the system 100 according to the present invention which provides web applications and services in a virtual environment, an operational status of the application in each virtual machine is monitored. In a case where a problem is found in the operation of the application through the monitoring processing, the virtual machine in which that application operates is canceled, and the application is rearranged by newly creating a virtual machine including the application. At this time, the scheduler ID for identifying the scheduler 106 is different from the scheduler ID before reactivation.

FIG. 10 is a flowchart illustrating a flow of processing for registering a task in the database 111 by the scheduler 106 or 110.

In step S1001, the scheduler 106 or 110 receives a request for registering the task information and takes out the task information as a registration target from the request. The request is received through the web API. The content of the task information to be taken out includes the information about items such as “Task Name” for uniquely identifying a task, “Scheduled Execution Date/Time”, “Repetition Setting”, “Task Type”, and “Detail”. Herein, if the task is not a repetitive task, there is no information about the item “Repetition Setting”. Further, if the task is a repetitive task, there is no information about the item “Scheduled Execution Date/Time”.

In step S1002, the scheduler 106 or 110 checks whether the task information having the information specified by the item “Task Name” of the task information taken out in step S1001 has already been registered and is present in the database 111. After checking, if the task information has not yet been registered in the database 111 (NO in step S1002), the processing proceeds to step S1003. If the task information has already been registered in the database 111 (YES in step S1002), the processing is ended without registering the task information.

In step S1003, the scheduler 106 or 110 determines whether the repetition setting is specified in the item “Repetition Setting” of the task information taken out in step S1001. If the task is the repetitive task to which the repetition is set (YES in step S1003), the processing proceeds to step S1004. If the repetition is not set to the task (NO in step S1003), the processing proceeds to step S1005.

In step S1004, the scheduler 106 or 110 calculates the next execution timing (Year/Month/Date/Time) from the content specified in the item “Repetition Setting” of the task information taken out in step S1001. Subsequently, the scheduler 106 or 110 sets the schedule information indicating the next execution timing acquired from the above calculation to the item “Scheduled Execution Date/Time” of the task information.

In step S1005, the scheduler 106 or 110 sets the identification information for identifying itself to the item “Scheduler ID”, stores the task information in the database 111, and ends the processing. The task information stored in the database 111 is managed by the above-described task information table.

The present invention also includes a device, a system, or a method realized by appropriately combining the above-described exemplary embodiments.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-140048, filed Jul. 13, 2015, which is hereby incorporated by reference herein in its entirety.

What is claimed is:

1. A system capable of establishing one or more execution environments in which a task corresponding to task information managed by a database is executed, the system comprising:
a plurality of execution control units configured to respectively operate in a plurality of execution environments,
wherein a first mode is set to any one execution control unit from among a plurality of the execution control units as an operation mode whereas a second mode different from the first mode is set to the other execution control units as operation modes,
wherein each of the execution control units controls execution of a task corresponding to task information conforming to a first condition from among the task information managed in the database which is associated with identification information of one of the execution control units, and
wherein the execution control unit to which the first mode is set controls execution of a task corresponding to task information managed by the database which conforms to a second condition different from the first condition.

2. The system according to claim 1, wherein the execution control unit to which the first mode is set stores in the database an environment identifier indicating its own operating execution environment.

3. The system according to claim 2,
wherein, in a case where an execution control unit is activated in an execution environment indicated by the environment identifier stored in the data base, the first mode is set to the activated execution control unit as the operation mode, and
wherein, in a case where an execution control unit is activated in an execution environment different from the execution environment indicated by the environment identifier stored in the database, the second mode is set to the activated execution control unit as the operation mode.

4. The system according to claim 1, wherein, in a case where a request for registration of the task information is received, the execution control units register, in the database in association with the task information, the identification information of each execution control unit.

5. The system according to claim 4, wherein, in a case where repetition is set to the task information included in the request, the execution control units respectively operating in a plurality of the execution environments register the task information in the database after setting a next execution timing of a task corresponding to the task information.

6. The system according to claim 1, wherein, in a case where switching processing of an execution environment is performed in which an operation mode of the execution control unit to which the second mode is set is changed to the first mode, execution control of the task performed by the execution control unit to which the first mode has been set prior to the switching processing is stopped.

7. The system according to claim 1, wherein the task information conforming to the second condition is task information which is not associated with any of identification information of a plurality of the execution control units respectively operating in a plurality of the execution environments.

8. The system according to claim 7, wherein, when the execution control unit to which the first mode is set acquires the task information conforming to the second condition from the database and controls execution of a task corresponding to the acquired task information, the execution control unit to which the first mode is set registers the task information in the database in association with its own identification information.

9. The system according to claim 1,
wherein information indicating a task type is included in the task information, and
wherein a task corresponding to the task information is executed by an execution method according to the information.

10. The system according to claim 1, wherein an execution environment, in which the execution control unit operates and to which the first mode is set, releases a service to a client outside the system.

11. A control method of a system capable of establishing one or more execution environments in which a task corresponding to task information managed by a database is executed, the control method comprising:
setting a first mode to any one execution control unit from among a plurality of execution control units respectively operating in a plurality of execution environments as an operation mode, and setting a second mode different from the first mode to the other execution control units as operation modes;
controlling, by each of the execution control units, execution of a task corresponding to task information conforming to a first condition from among the task information managed in the database which is associated with identification information of one of the execution control units; and
controlling, by the execution control unit to which the first mode is set, execution of a task corresponding to task information managed in the database which conforms to a second condition different from the first condition.

12. The control method according to claim 11, wherein the execution control unit to which the first mode is set stores in the database an environment identifier indicating its own operating execution environment.

13. The control method according to claim 12,
wherein, in a case where an execution control unit is activated in an execution environment indicated by the environment identifier stored in the data base, the first mode is set to the activated execution control unit as the operation mode, and
wherein, in a case where an execution control unit is activated in an execution environment different from the execution environment indicated by the environment identifier stored in the database, the second mode is set to the activated execution control unit as the operation mode.

14. The control method according to claim 11, wherein, in a case where a request for registration of the task information is received, the execution control units register, in the database in association with the task information, the identification information of each execution control unit.

15. The control method according to claim 11, wherein the task information conforming to the second condition is task information which is not associated with any of identification information of a plurality of the execution control units respectively operating in a plurality of the execution environments.
